(19) United States
(12) Patent Application Publication
(10) Pub. No.: US 2014/0173529 A1
(43) Pub. Date: Jun. 19, 2014

(54) CIRCULAR GESTURE FOR TOUCH SENSITIVE UI CONTROL FEATURE

(71) Applicant: BARNESANDNOBLE.COM LLC, New York, NY (US)

(72) Inventor: Kourtny M. Hicks, Sunnyvale, CA (US)

(73) Assignee: barnesandnoble.com llc, New York, NY (US)

(21) Appl. No.: 13/715,262

(22) Filed: Dec. 14, 2012

(51) Int. Cl. G06F 3/01

(52) U.S. Cl. CPC G06F 3/017
USPC 715/863

(57) ABSTRACT

Techniques are disclosed for providing a circular gesture mode in electronic touch sensitive devices. The user can engage the mode with a particular gesture that includes a combination of contact points that uniquely identify that the circular gesture mode is desired. The combination may include, for example, a press-and-hold activation contact point in conjunction with one or more additional contact points moving in a circular motion, or a multiple contact points moving circular motion. The circular gesture can be used to cause, for instance, specific functions within a given application, and/or within different applications. Clockwise movement can be used to cause one type of change, while counter-clockwise motion can be used to cause another type. Changing pages, sections, and chapters of a book, or changing volume of an audio application, or changing a tool within a given application, or from changing from one application to another are example uses.

### FIELD OF THE DISCLOSURE

This disclosure relates to electronic display devices, and more particularly, to user interface techniques for interacting with touch sensitive devices.

### BACKGROUND

Electronic display devices such as tablets, eReaders, mobile phones, smart phones, personal digital assistants (PDAs), and other such touch screen electronic display devices are commonly used for displaying consumable content. The content may be, for example, an eBook, an online article or blog, images, a movie or video, a map, just to name a few types. Such display devices are also useful for displaying a user interface that allows a user to interact with an application running on the device. The user interface may include, for example, one or more touch screen controls and/or one or more displayed labels that correspond to nearby hardware buttons. The touch screen display may be backlit or not, and may be implemented for instance with an LED screen or an electrophoretic display. Such devices may also include other touch sensitive surfaces, such as a track pad (e.g., capacitive or resistive touch sensor) or touch sensitive housing (e.g., acoustic sensor).

### BRIEF DESCRIPTION OF THE DRAWINGS

FIGS. 1a-b illustrate an example electronic touch sensitive device having a circular gesture mode configured in accordance with an embodiment of the present invention.

FIGS. 1c-i illustrate example configuration screen shots of the user interface of the electronic touch sensitive device shown in FIGS. 1a-b, configured in accordance with an embodiment of the present invention.

FIGS. 2a illustrates a block diagram of an electronic touch sensitive device configured in accordance with an embodiment of the present invention.

FIGS. 2b illustrates a block diagram of a communication system including the electronic touch sensitive device of FIG. 2b, configured in accordance with an embodiment of the present invention.

FIGS. 3a-d each illustrates an example circular gesture that can be applied to a touch sensitive surface of an electronic device, in accordance with an embodiment of the present invention.

FIG. 4 illustrates a method for providing a circular gesture mode in an electronic touch sensitive device, in accordance with an embodiment of the present invention.

### DETAILED DESCRIPTION

Techniques are disclosed for providing a circular gesture mode in electronic touch sensitive devices. The user can engage the mode with a particular gesture that includes a combination of contact points that uniquely identify that the circular gesture mode is desired. The combination may include, for example, a press-and-hold activation contact point in conjunction with one or more additional contact points moving in a circular motion, or a multiple contact points moving circular motion. The circular gesture can be used to cause, for instance, specific functions within a given application, and/or within different applications. Clockwise movement can be used to cause one type of change, while counter-clockwise motion can be used to cause another type. Changing pages, sections, and chapters of a book, or changing volume of an audio application, or changing a tool within a given application, or from changing from one application to another, or changing brightness of a display are a few example uses.

General Overview

As previously explained, electronic display devices such as tablets, eReaders, and smart phones are commonly used for displaying user interfaces and consumable content. The user of such devices can typically interact with the device with relative ease. In some instances, however, the user might prefer a more customized user interaction scheme that can be uniquely activated on a global level to enhance the user experience. While available touch-based interface techniques typically include gestures such as swiping and tapping to cause certain functions, those same techniques tend to be relatively one-dimensional and fail to fully utilize the touch diversity readily available at the touch sensitive interface. This failure effectively translates to a diminished user experience.

Thus, and in accordance with an embodiment of the present invention, techniques are disclosed for providing a circular gesture mode in electronic touch sensitive devices, such as touch screen and track pad devices. The circular gesture mode can be used as a control for user interface objects in numerous ways. The user can engage the mode with a particular gesture that includes a combination of contact points that uniquely identify that the circular gesture mode is desired. The combination may include, for example, a press-and-hold activation contact point and one or more additional contact points moving in a circular motion, or a multiple contact point circular motion. In some cases, a fixed activation point is provided by one hand of the user, and the circular motion contact points are provided by the user's other hand. The specific action caused by the overall contact can be based on, for example, the placement and/or number of the activation points, the placement and/or number of the circular motioning points, or any combination thereof.

In some embodiments, the circular gesture can be used to cause specific functions within a given application. For instance, a one contact point circular gesture can be used to advance one page in an eBook, a two contact point circular gesture can be used to advance to the next section of the eBook, and a three contact point circular gesture can be used to advance to the next chapter of the eBook. In another example application, a one contact point circular gesture can be used to change volume in an audio application, and a two contact point circular gesture can be used to change volume in the audio application at twice the rate of the one contact point gesture.

In another example case, a circular gesture having a specific number of contact points can be used to change to a tool within a given application. For example, a two contact point circular gesture can be used to change from a typing/text tool to audio recording tool within an application. In a similar fashion, a circular gesture having a specific number of contact points can be used to change from one application to another. For instance, a three contact point circular gesture can be used to change from a browser application to an email or messaging application. Numerous such tool and application switches will be apparent in light of this disclosure.

In other cases, the circular gesture can be used to cause specific functions within different applications. For instance, a two contact point circular gesture can be used to change the volume of an audio application and a five contact point circular gesture can be used to advance one page of an eBook. In a similar fashion, a single activation contact point and a single circular gesture contact point can be used to scroll search results in a browser application and two activation contact point in conjunction with a single circular gesture contact point can be used to scroll files in a file storage application.

In some example cases, clockwise movement can be used to cause a forward or increasing effect on the object of interest, and a counter-clockwise movement can be used to cause a backward or decreasing effect on the object of interest. For instance, clockwise motion can be used to increase volume in an audio application or a forward page advance in an eBook, while counter-clockwise motion can be used to decrease volume in the audio application or a backward page advance in the eBook.

The techniques can be implemented in an intuitive manner, giving the user a fuller benefit of the touch diversity readily available at the touch sensitive interface, in accordance with some embodiments. The user may configure any number of scenarios. Each set of contact points can be assigned a specific meaning, at the application level and/or the global level. Numerous applications and multi-point circular gesture schemes will be apparent in light of this disclosure, whether including both activation point(s) and circular motioning points, or just circular motioning points.

User Interface and Mode Configuration

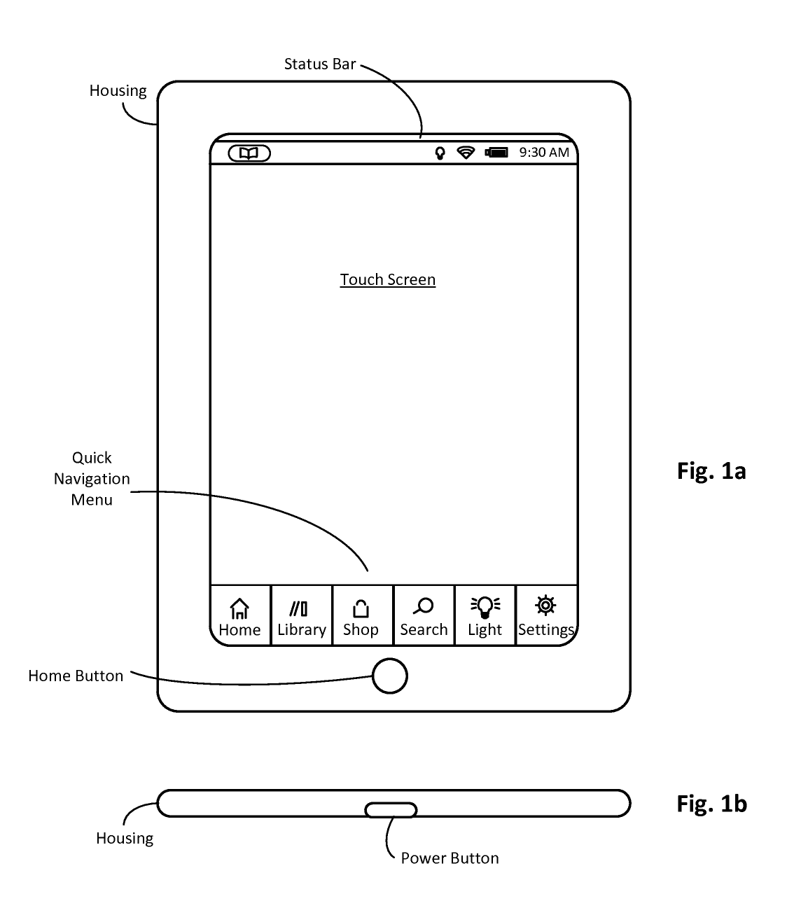

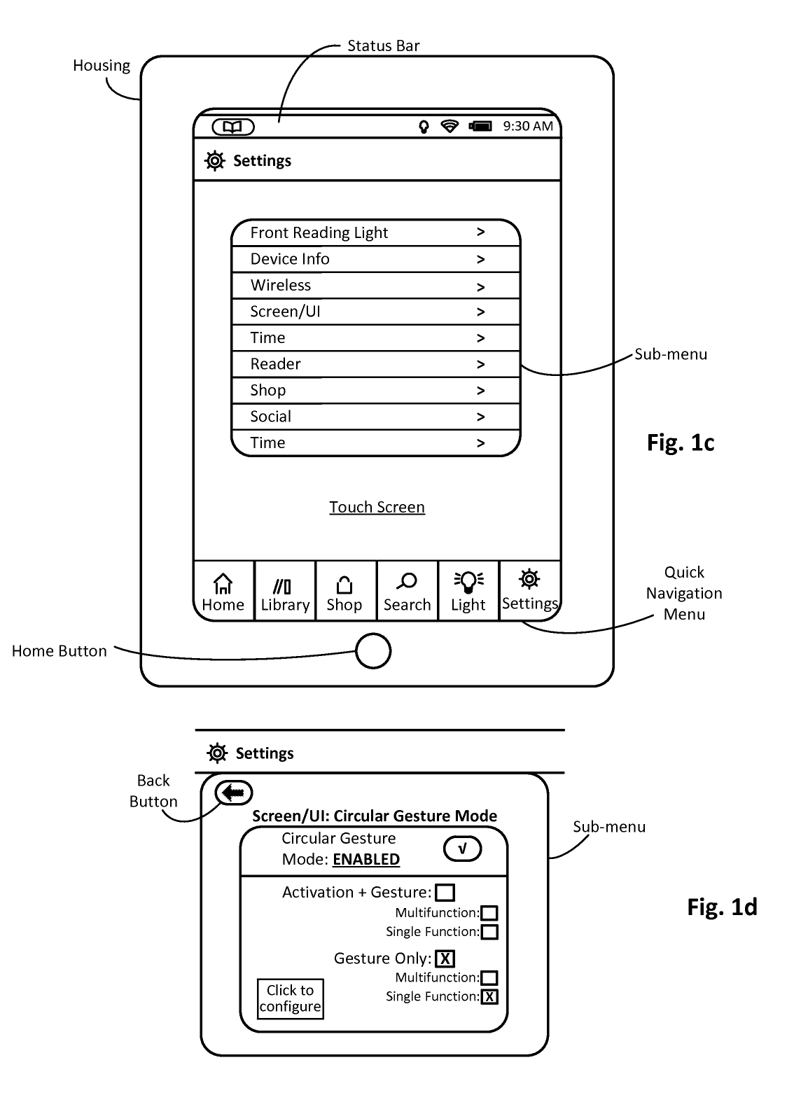

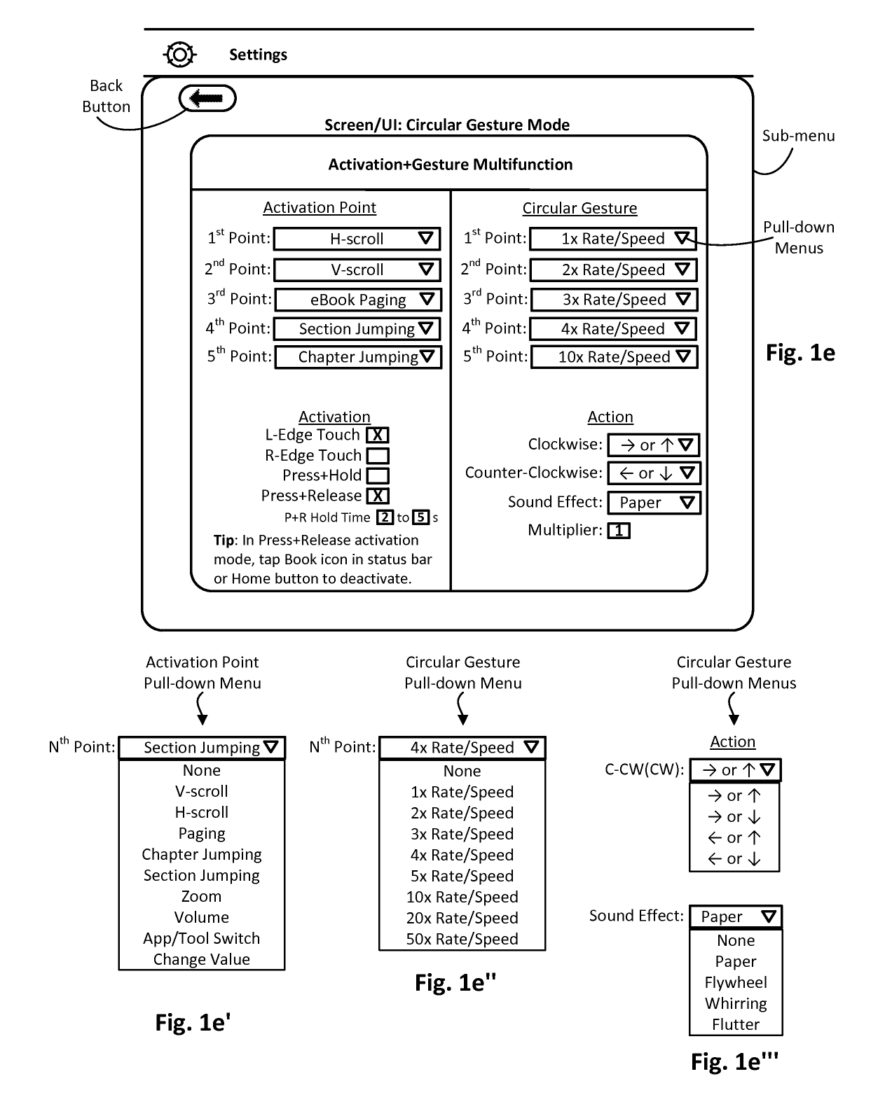

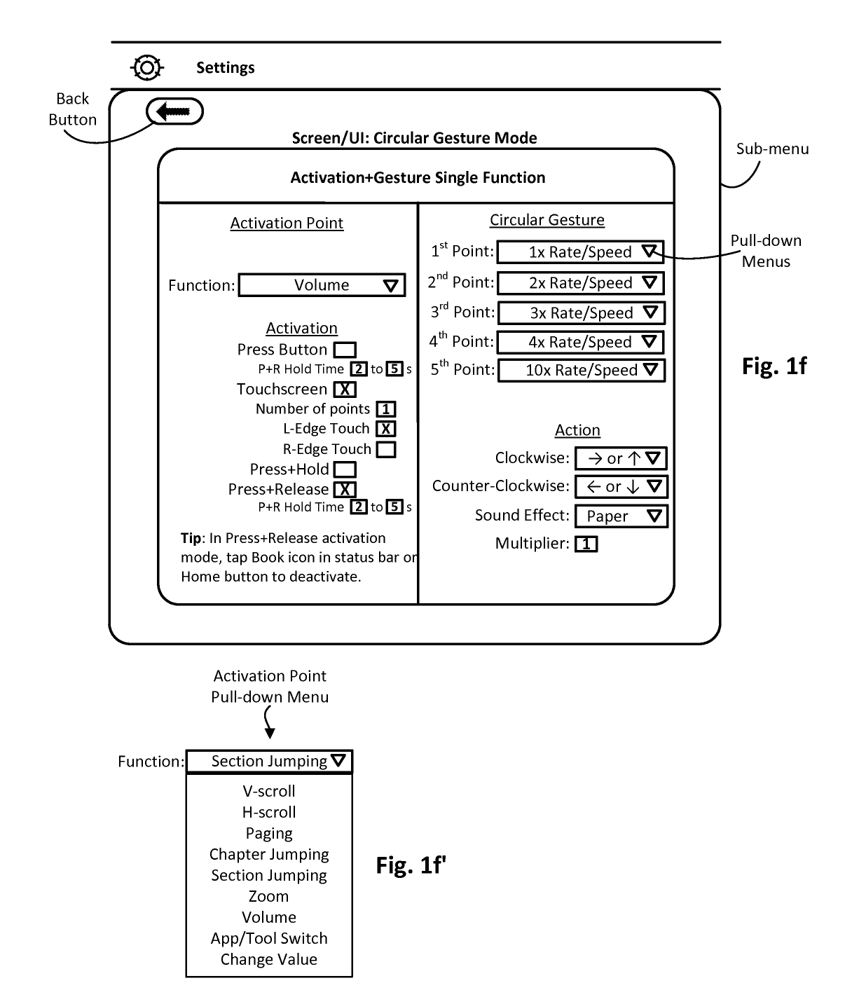

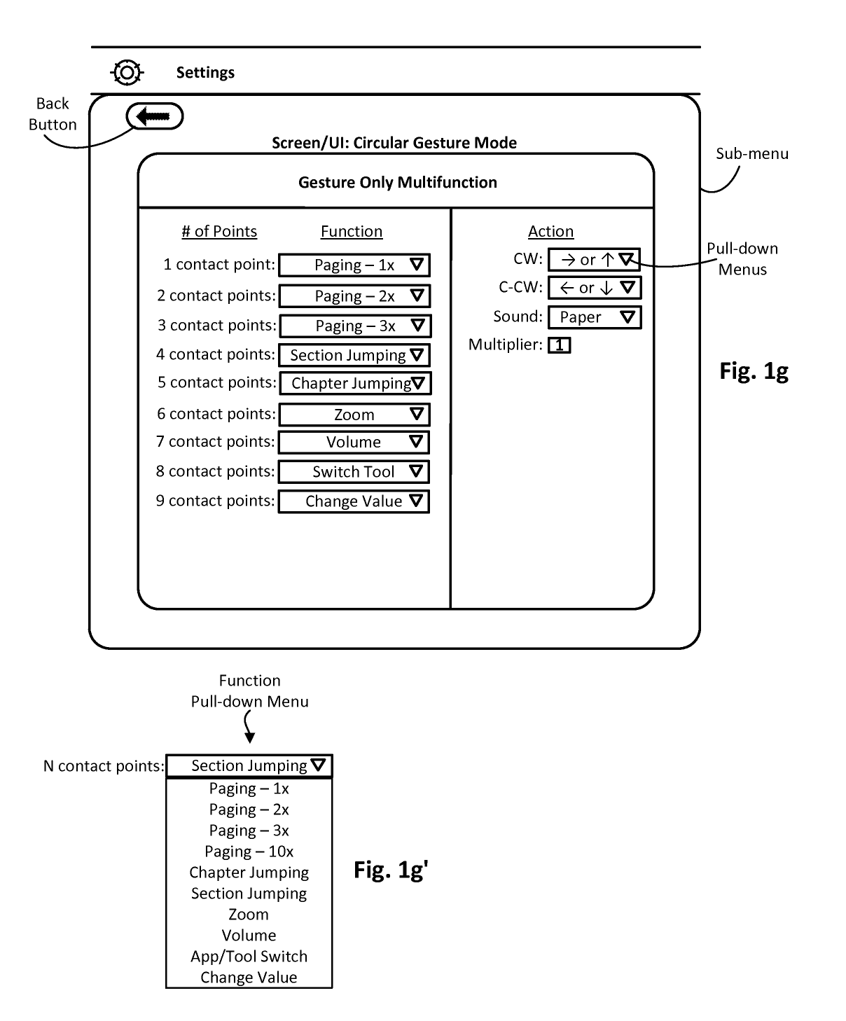

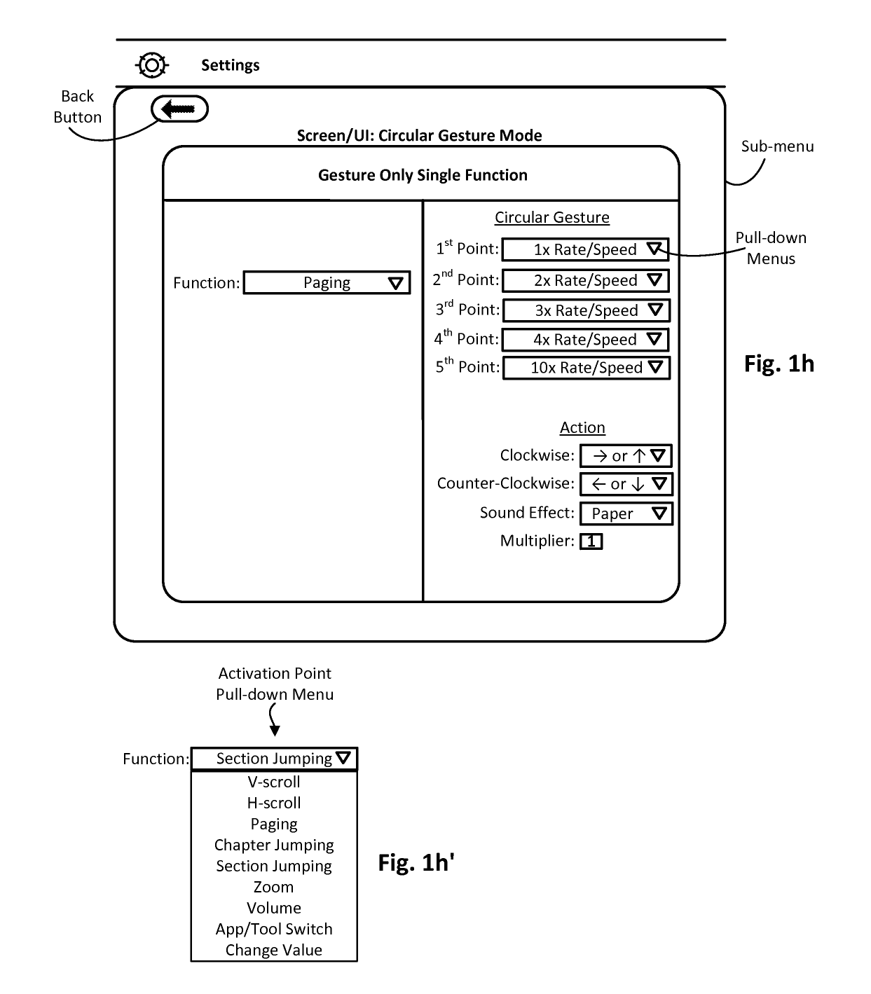

FIGS. 1a-b illustrate an example electronic touch sensitive device having a circular gesture mode configured in accordance with an embodiment of the present invention. The device could be, for example, a tablet such as the NOOK® Tablet by Barnes & Noble. In a more general sense, the device may be any electronic device having a touch sensitive user interface and capability for displaying content to a user, such as a mobile phone or mobile computing device such as a tablet or laptop, a desktop computing system, a television, a smart display screen, or any other device having a touch screen display or a non-touch display screen that can be used in conjunction with a touch sensitive surface. As will be appreciated, the claimed invention is not intended to be limited to any particular kind or type of electronic device.

As can be seen with this example configuration, the device comprises a housing that includes a number of hardware features such as a power button and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used as follows: when the device is awake and in use, tapping the button will display the quick navigation menu, which is a toolbar that provides quick access to various features of the device. The home button may also be configured to cease an active function that is currently executing on the device, such as a circular gesture mode as described herein. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device was stowed into a bag or purse. One physical gesture that would safely put the device to sleep. Thus, in such an example embodiment, the home button may be associated with and control different and unrelated actions: 1) show the quick navigation menu; 2) exit the circular gesture mode, but keep the page being read or otherwise consumed displayed (e.g., so that another mode can be entered, if so desired); and 3) put the device to sleep. Numerous other configurations and variations will be apparent in light of this disclosure, and the claimed invention is not intended to be limited to any particular set of hardware buttons or features, or device form factor.

As can be further seen, the status bar may also include a book icon (upper left corner). In some such cases, the user can access a sub-menu that provides access to a circular gesture mode configuration sub-menu by tapping the book icon of the status bar. For example, upon receiving an indication that the user has touched the book icon, the device can then display the circular gesture mode configuration sub-menu shown in FIG. 1d. In other cases, tapping the book icon just provides bibliographic information on the content being consumed. Another example way for the user to access a circular gesture mode configuration sub-menu such as the one shown in FIG. 1d is to tap or otherwise touch the Settings option in the quick navigation menu, which causes the device to display the general sub-menu shown in FIG. 1c. From this general sub-menu the user can select any one of a number of options, including one designated Screen/UI in this specific example case. Selecting this sub-menu item (with an appropriately placed screen tap) may cause the circular gesture mode configuration sub-menu of FIG. 1d to be displayed, in accordance with an embodiment. In other example embodiments, selecting the Screen/UI option may present the user with a number of additional sub-options, one of which may include a so-called circular gesture mode option, which may then be selected by the user so as to cause the circular gesture mode configuration sub-menu of FIG. 1d to be displayed. Any number of such menu schemes and nested hierarchies can be used, as will be appreciated in light of this disclosure.

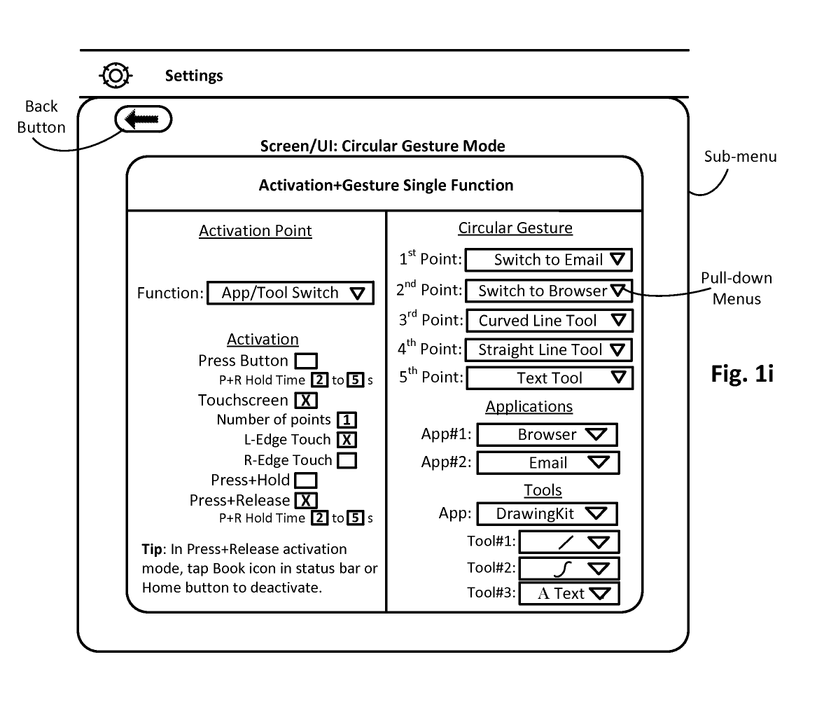

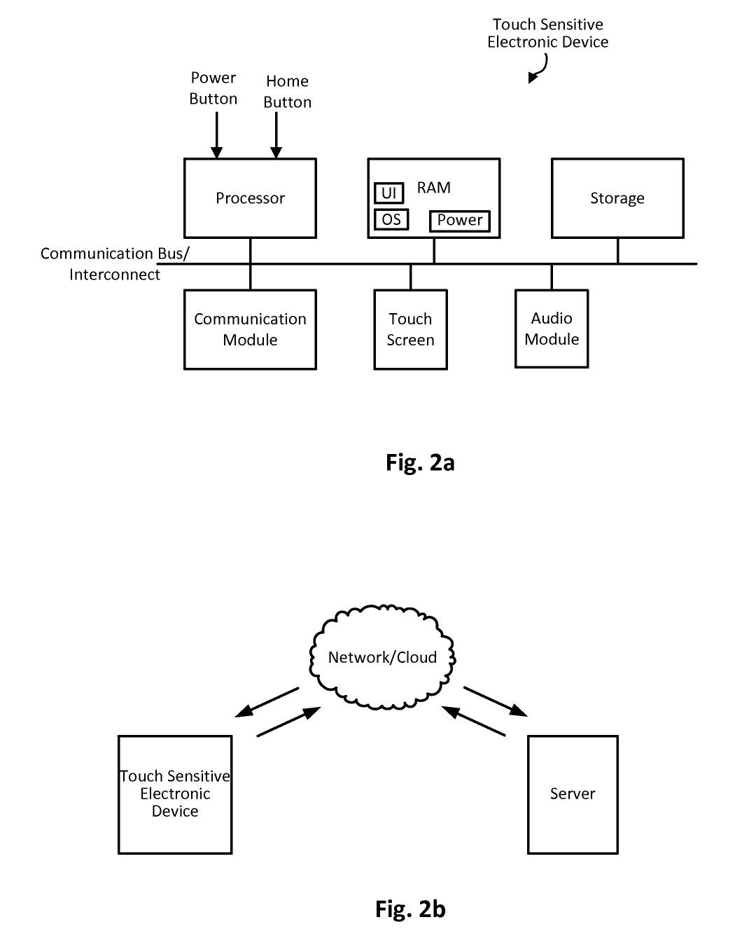

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc). Additional example details of the underlying OS and circuitry in accordance with some embodiments will be discussed in turn with reference to FIG. 2a.

As previously explained, and with further reference to FIGS. 1c and 1d, once the Settings sub-menu is displayed (FIG. 1c), the user can then select the Screen/UI option. In response to such a selection, the circular gesture mode configuration sub-menu shown in FIG. 1d can be provided to the user. In this example case, the circular gesture mode configuration sub-menu includes a UI check box that when checked or otherwise selected by the user, effectively enables the circular gesture mode (shown in the enabled state); unchecking the box disables the mode. Other embodiments may have the circular gesture mode always enabled, or enabled by a physical switch or button, for example. The user can configure a number of features with respect to the circular gesture mode, in some cases.

In this example case, once the circular gesture mode is enabled, the user can choose between two main types of the mode by checking the corresponding check box. As can be seen with respect to FIG. 1d, one mode type is the Activation+Gesture type and the other main mode type is the Gesture Only type. For each of these types, the user is further allowed to specify Multifunction or Single Function operation, by again checking a corresponding check box. Once the user has selected the type of operation desired, the user can then select the Click to configure button to proceed with the relevant configuration, which can be programmed or otherwise configured to cause another configuration page to be provided to the user, in accordance with an embodiment. Each of FIGS. 1e through 1i illustrates example such further configuration pages based on different initial configuration selections by the user provided at the configuration screen of FIG. 1d, in accordance with an embodiment. For instance, in the example scenario shown in FIG. 1d, the Gesture Only and Single Function check boxes are checked, which in accordance with an embodiment causes the configuration page shown in FIGS. 1h and 1h′. Each of the configuration pages in FIGS. 1e through 1i which will now be discussed in turn.

FIG. 1e illustrates an example configuration page that can be provided to the user in response to the user selecting the Activation+Gesture type and Multifunction sub-type circular gesture mode at the initial configuration page of FIG. 1d, in accordance with an embodiment. As can be seen, the user can specify up to five different functions or actions depending on the number of activation contact points provided. Likewise, the user can specify up to five different rates or speeds at which those functions/actions can be carried out, depending on the number of circular gesture points provided. Thus, the action specified by the one or more fixed activation contact points is carried out in response to the one or more circular gesture contact points. As will be appreciated in light of this disclosure, the activation points can be provided, for instance, by one hand of the user, and the circular gesture points can be provided by the other hand of the user. Styluses or other implements may be used to provide contact points as well, and the claimed invention is not intended to be limited to any particular manner of causing the various contact points.

In the example scenario shown in FIG. 1e, each of five pull-down menus provisioned to configure the activation contact indicates a specific example user selection. In particular, a one contact point activation is assigned to a horizontal scroll (H-scroll) action, a two contact point activation is assigned to a vertical scroll (V-scroll) action, a three contact point activation is assigned to an eBook paging action, a four contact point activation is assigned to a section jumping action within an eBook (i.e., jump to next section from current location), and a five contact point activation is assigned to a chapter jumping action within an eBook (i.e., jump to next chapter from current location). FIG. 1e′ illustrates an example fully expanded activation point pull-down menu that can be provisioned for each of the five available contact points, in accordance with an example embodiment. Note the diverse nature of the example functions, including scrolling (V-scroll and H-scroll) for search results or file listings, Paging within an eBook, Chapter Jumping within an eBook, Section Jumping within an eBook, Zoom in or out for use any application, Volume within an audio/video application, App/Tool Switch (to change to or otherwise launch a particular application or tool), or Change Value (to change a user-configurable value, such as a date or time). Such a configuration feature may be helpful, for instance, in a tablet or laptop or other multifunction computing device that can execute different applications (as opposed to a device that is more or less dedicated to a particular application). For instance, in the example case shown, the circular gesture mode can be applied to an eBook application (e.g., navigating through a given eBook), a photo viewing application (e.g., paging from one photo to the next within a given camera roll or picture set, etc), a browser application (e.g., paging through search listings, etc), and/or a file manager application (e.g., paging through music file listings, eBook file listings, etc), if so desired. Any number of applications or device functions may benefit from a circular gesture mode as provided herein, whether user-configurable or not, and the claimed invention is not intended to be limited to any particular application or set of applications.

Further note with respect to FIG. 1e that the location of the activation point(s) can be configured by the user, for example, by checking the L-Edge Touch checkbox or the R-Edge Touch checkbox (for left or right edge touch screen activation, respectively). Thus, the user can effectively define which hand will provide the activation point(s) and which hand will provide the moving point(s) during circular gesture mode. In general, the user's dominant or preferred hand may be best suited to provide the moving points, but that need not necessarily be the case. Likewise, the user can further designate whether the activation points are press-and-hold or press-and-release in nature. For a press-and-hold configuration, the user can maintain the activation points throughout the motion of the circular gesture points, which some users may prefer. In such cases, when the user releases the activation point, the circular mode gesture effectively concludes.

On the other hand, with a press-and-release configuration, the user need not maintain the activation points throughout the motion of the circular gesture points. Rather, the user can hold the activation points for a set period of time (which may also be user-configurable, as shown in FIG. 1e), and the circular gesture mode will engage and continue thereafter. In the example case shown in FIG. 1e, a press-and-release activation point on the left edge of the touch sensitive surface that lasts 2 to 5 seconds will cause the circular gesture mode to activate. As will be appreciated in light of this disclosure, a configurable activation delay can be set to distinguish the circular gesture mode engagement sequence from other available modes of operation or functions. For instance, a given contact area of the touch sensitive surface of the device can be tapped (e.g., touch-and-release of 1 second or less) to launch a timer function or other application, or can be pressed-and-released (e.g., with a hold time 2 to 5 seconds) to engage the circular gesture function. In any case, once the circular gesture mode is engaged in response to the press-and-release activation point(s), an icon may be provided in the status bar to let the user know the circular gesture mode is enabled, and the user can tap the same activation point area to exit the mode, in some embodiments. Other indicators that can be used to inform that user of the press-and-release activation sequence has resulted in entry into the circular gesture mode will be apparent in light of this disclosure (e.g., change in color scheme, etc). Likewise, any number of gestures can be used to terminate or otherwise conclude the mode. For instance, the user may tap on the touch sensitive surface, or press the home button to exit the mode. In some cases, the mode may automatically terminate after a short delay following the release of motioning contact points. In such example embodiments, the short delay may be user configurable (e.g., 2 to 5 seconds).

With further reference to the example scenario shown in FIG. 1e, each of five pull-down menus provisioned to configure the circular gesture contact indicates a specific example user selection. In particular, a one contact point circular gesture executes the designated action at a 1× speed/rate, a two contact point circular gesture executes the designated action at a 2× speed/rate, a three contact point circular gesture executes the designated action at a 3× speed/rate, a four contact point circular gesture executes the designated action at a 4× speed/rate, and a five contact point circular gesture executes the designated action at a 10× speed/rate. FIG. 1e″ illustrates an example fully expanded circular gesture point pull-down menu that can be provisioned for each of the five available contact points, in accordance with an example embodiment.

As can be further seen, the user may also assign a given action to the circular gesture based on whether the gesture is clockwise or counter-clockwise. In the example case shown in FIG. 1e, clockwise motion is assigned (via a pull-down menu) to provide forward advancement (→) or increasing values (↑), while counter-clockwise motion is assigned to provide backward advancement (←) or decreasing values (↓). As can be further seen, another pull-down menu is provided that allows the user to select a sound effect that can be provided when the action is carried out (e.g., such as the sound of an actual page or pages being turned, for a page turning action), if so desired. In one specific example embodiment, each type of action (e.g., 1-page turn, 2-page turn, section advance, chapter advance, volume increase, volume decrease, etc) can be associated with a distinct or otherwise appropriate sound, so as to enhance the user's experience. The sounds provided may be arbitrary, and may also be downloaded to the device from other sources, if so desired. FIG. 1e′″ illustrates example fully expanded action pull-down menus that can be provisioned for the clockwise (CW) and counter-clockwise (C-CW) action assignment and sound effect selection, in accordance with an example embodiment.

As can be further seen with reference to the example embodiment of FIG. 1e, the user can specify a multiplier associated with the circular gestures, so that the rate or speed per circular gesture is the product of the number of moving contact points and the multiplier. For example, a clockwise 5-point circular gesture (one complete circle) with a multiplier of 5 will yield a 25-page forward advance. Such large paging increments may be helpful, for instance, when thumbing or otherwise scanning a voluminous text or treatise, or paging through an alphabetical listing of 1000+ music files beginning in the ‘A’ section and paging quickly to the ‘M’ section. Section and chapter jumping actions can also be very useful in such situations, as will be appreciated in light of this disclosure. Note that any combination of the actions may be selected or otherwise configured to provide the user with various interface choices and assist the user experience. If no multiplying effect is desired, the multiplier can be set to 1, as shown in FIG. 1e.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired.

FIG. 1f illustrates an example configuration page that can be provided to the user in response to the user selecting the Activation+Gesture type and Single Function sub-type circular gesture mode at the initial configuration page of FIG. 1d, in accordance with an embodiment. As can be seen, the right side of the configuration page is similar to that shown in FIG. 1e, and the previous relevant discussion is equally applicable here. However, on the left side of the configuration page, only a single function can be specified. FIG. 1f illustrates an example fully expanded activation point pull-down menu that can be provisioned to designate the function, in accordance with an example embodiment. Note the diverse nature of the example functions, as previously explained.

Further note with respect to FIG. 1f that the location of the activation point(s) can be configured by the user, for example, by checking either the Press Button check box or the Touchscreen check box. The press button may be, for instance, the home button or some other hardware feature that the user can press-and-release (with a hold time in the specified range) so as to activate the circular gesture mode. If the user wishes to use the touchscreen to activate the mode, then the user may specify the number of activation contact points as well as the location of those contact points. In this example case shown in FIG. 1f, the user has specified a single contact activation point and has checked the L-Edge Touch checkbox. In addition, the user has designated a press-and-release activation sequence, as previously discussed. Thus, in this example case, a single contact point on the left side of the touch sensitive screen (or other touch sensitive surface) that is held for 2 to 5 seconds and then released with activate the circular gesture mode.

Once configured, the user can use circular gestures including one to five contact points (in this example case) to effect the selected action at a given rate. As can be seen, the selected action is volume control in this example scenario. Thus, as configured in this example case, a one contact point circular gesture in the clockwise direction will increase the volume at a given rate, while a two contact point circular gesture in the clockwise direction will increase the volume at twice the given rate. Similarly, a three contact point circular gesture in the clockwise direction will increase the volume at three-times the given rate, a four contact point circular gesture in the clockwise direction will increase the volume at four-times the given rate, and a five contact point circular gesture in the clockwise direction will increase the volume at five-times the given rate. Such contact points in the counter-clockwise direction will yield corresponding decreases in the given rate.

FIG. 1g illustrates an example configuration page that can be provided to the user in response to the user selecting the Gesture Only type and Multifunction sub-type circular gesture mode at the initial configuration page of FIG. 1d, in accordance with an embodiment. As will be appreciated in light of this disclosure, no activation points are needed in such a configuration. As can be seen, right side of the configuration page includes features similar to that shown in FIG. 1e, and the previous relevant discussion is equally applicable here. However, on the left side of the configuration page, any one of a plurality of functions can be assigned to any one of nine circular gestures (ranging from one to nine contact points). FIG. 1g′ illustrates an example fully expanded function pull-down menu that can be provisioned for allowing the user to assign a function for the corresponding N contact point, in accordance with an example embodiment. In this example case, a one contact point circular gesture will advance paging by one page, a two contact point circular gesture will advance paging by two pages, a three contact point circular gesture will advance paging by three pages, a four contact point circular gesture will advance paging to the next section, and a five contact point circular gesture will advance paging to the next chapter.

Continuing with the example shown, a six contact point circular gesture will cause a zoom action. Note in this example case that not all of the six points need to be moving in circular motion. For instance, five contact points of one hand (or implement) can be moving in circular motion while the sixth contact point is provided in a fixed fashion by the user's other hand (or implement). As will be appreciated, similar comments apply to a seven contact point circular gesture for controlling volume, and an eight contact point circular gesture for causing a tool switch, and a nine contact point circular gesture for causing a change in value, as shown in this example. Again, the direction of circular motion can be used to indicate how to effect the change (e.g., CW for increase/C-CW for decrease, or CW for forward paging/C-CW for backward paging, etc).

FIG. 1h illustrates an example configuration page that can be provided to the user in response to the user selecting the Gesture Only type and Single Function sub-type circular gesture mode at the initial configuration page of FIG. 1d, in accordance with an embodiment. Again, no activation points are needed in such a configuration. As can be seen, right side of the configuration page includes features similar to that shown in FIG. 1e, and the previous relevant discussion is equally applicable here. However, on the left side of the configuration page, a single pull-down menu is provisioned for allowing the user to assign a specific function to circular gesture. FIG. 1h′ illustrates an example fully expanded function pull-down menu that can be provisioned to designate the function for the circular gesture, in accordance with an example embodiment. In this example case, the number of contact points in the circular gesture will dictate the rate or speed at which that function is executed in response to the user's circular gesture. In this example case the function is paging, and a one contact point circular gesture causes a one page advancement, a two contact point circular gesture causes a two page advancement, a three contact point circular gesture causes a three page advancement, a four contact point circular gesture causes a four page advancement, and a five contact point circular gesture causes a ten page advancement. Previous discussion with respect to direction of circular motion equally applies here.

FIG. 1i illustrates an example configuration page that can be provided to the user in response to the user selecting the Activation+Gesture type and Single Function sub-type circular gesture mode at the initial configuration page of FIG. 1d, in accordance with another embodiment. As can be seen, the left side of the configuration page is similar to that shown in FIG. 1f, and the previous relevant discussion is equally applicable here. However, as can further be seen with reference to FIG. 1i, the selected function on the left side of the configuration page is the App/Tool Switch, which in turn causes the right side of the configuration page to be provisioned with a specific set of pull-down menus relevant to the App/Tool Switch function. In this example case, a one contact point circular gesture causes the email application to launch or otherwise come to the front screen, a two contact point circular gesture causes the browser application to launch or otherwise come to the front screen, a three contact point circular gesture causes the curved line tool to be engaged, a four contact point circular gesture causes the straight line tool to be engaged, and a five contact point circular gesture causes the text tool to be engaged. In such cases, the direction of motion of the gesture may not have any affect, in accordance with some embodiments. In other example embodiments, a circular gesture motion in one direction may cause the application/tool switch, and a circular gesture motion in the other direction causes a switch back to the previous application or tool.

Further note with respect to FIG. 1i that the user can select the applications to be switched to (or from). In this example case, the use has specified a first application to be the local browser application and a second application to be the local email application. As will be appreciated in light of this disclosure, any number of applications can be specified, and no set number or range applications is intended to be defined by this example embodiment. Likewise, the user can also specify the application in which tools can be switched or otherwise activated and deactivated. In this example case, the user has specified a drawing application (DrawingKit), and has defined the tools to be used in the tool switch circular gestures (3-point, 4-point, and 5-point, in this example). Specifically, Tool#1 is the straight line tool, Tool#2 is the curved line tool, and Tool #3 is the text tool. Numerous configurations will be apparent in light of this disclosure.

Architecture

FIGS. 2a illustrates a block diagram of an electronic touch screen device configured in accordance with an embodiment of the present invention. As can be seen, this example device includes a processor, random access memory (RAM), additional storage/memory, a communications module, a touch screen, and an audio module. A communications bus and interconnect is also provided to allow inter-device communication. Other typical componentry and functionality not reflected in the block diagram will be apparent (e.g., battery, co-processor, etc). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's physical contact with the surface into an electronic signal that can be manipulated or otherwise used to trigger a specific user interface action, such as those provided herein. The principles provided herein equally apply to any such touch sensitive devices. For ease of description, examples are provided with touch screen technology.

In this example embodiment, the RAM includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc), and encoded on a machine readable medium, that when executed by the processor (and/or co-processors), carries out the functionality of the device including a UI having a circular gesture mode as variously described herein. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments OMAP3621 applications processor), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The RAM can be any suitable type of memory and size (e.g., 256 or 512 Mbytes SDRAM), and in other embodiments may be implemented with non-volatile memory or a combination of non-volatile and volatile memory technologies. The storage can also be implemented with any suitable memory and size (e.g., 2 GBytes of flash memory). The display can be implemented, for example, with a 6-inch E-ink Pearl 800×600 pixel screen with Neonode® zForce® touchscreen, or any other suitable display and touchscreen interface technology. The communications module can be, for instance, any suitable 802.11 b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc). The device may be smaller, for example, for smartphone and tablet applications and larger for smart computer monitor and laptop applications.

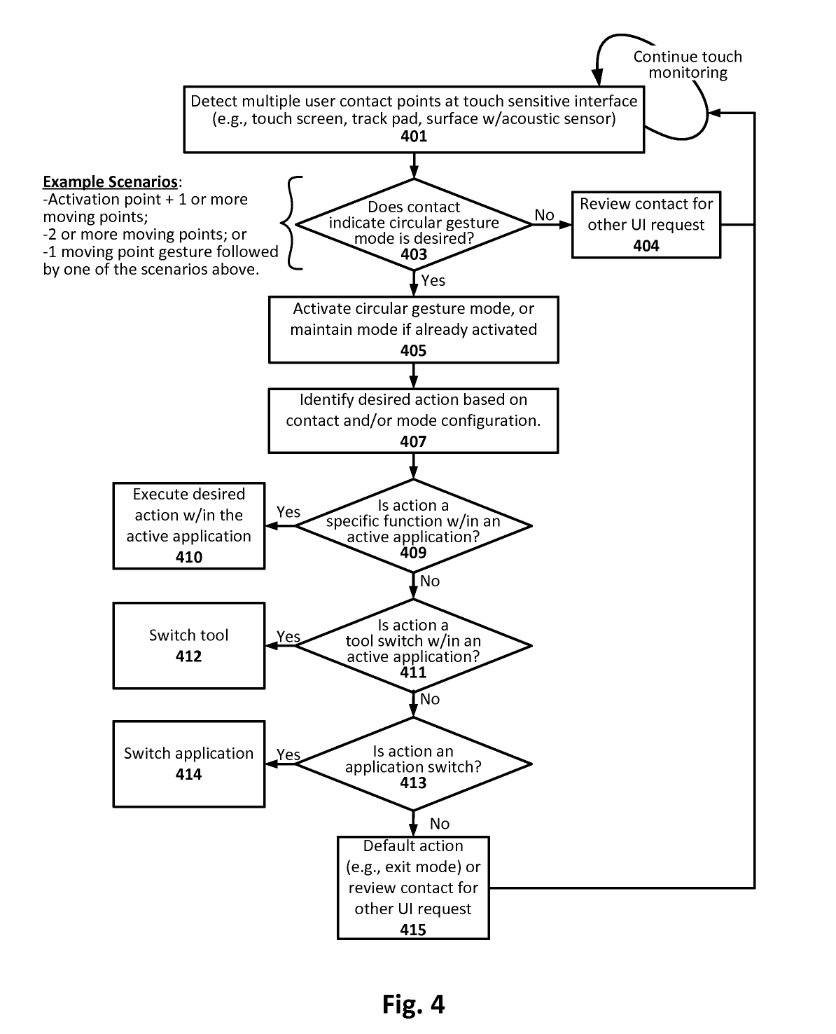

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The user interface (UI) module can be, for example, based on touchscreen technology and the various example screen shots shown in FIGS. 1a-i and 3a-d in conjunction with the circular gesture mode methodologies demonstrated in FIG. 4, which will be discussed in turn. The audio module can be configured, for example, to speak or otherwise aurally present a selected eBook or other textual content, if preferred by the user. Numerous commercially available text-to-speech modules can be used, such as Verbose text-to-speech software by NCH Software. In such audio-based cases, note that the navigation function as described herein can be used to identify the textual content to be converted to audio. In some example cases, if additional space is desired, for example, to store digital books or other content and media, storage can be expanded via a microSD card or other suitable memory expansion technology (e.g., 32 GBytes, or higher).

Client-Server System

FIGS. 2b illustrates a block diagram of a communication system including the electronic touch sensitive device of FIG. 2b, configured in accordance with an embodiment of the present invention. As can be seen, the system generally includes an electronic touch sensitive device that is capable of communicating with a server via a network/cloud. In this example embodiment, the electronic touch sensitive device may be, for example, an eBook reader, a mobile cell phone, a laptop, a tablet, desktop, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. Is some such embodiments, the server is configured to remotely provision a circular gesture mode as provided herein to the touch sensitive device (e.g., via JavaScript or other browser based technology). In other embodiments, portions of the methodology are executed on the server and other portions of the methodology are executed on the device. Numerous server-side/client-side execution schemes can be implemented to facilitate a circular gesture mode in accordance with an embodiment, as will be apparent in light of this disclosure.

Multi-Touch Navigation Examples

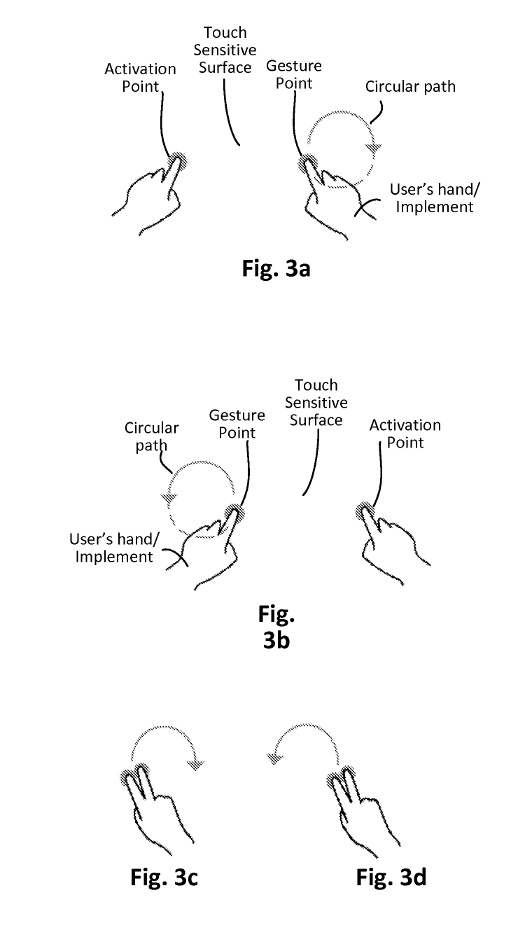

FIGS. 3a-d each illustrates an example circular gesture that can be applied to a touch sensitive surface of an electronic device, in accordance with an embodiment of the present invention. As can be seen, the device includes a touch sensitive surface, which may be, for example, a touch screen display, a track pad, or any other touch sensitive surface for receiving a multi-touch point user input.

In the example engagement mode shown in FIG. 3a, the user is using a one contact point circular gesture in the clockwise direction. In some embodiments, one complete circle can be translated to one complete action (e.g., forward 1-page, increase volume 10%, scroll down 1-page, change from browser to email app, etc). FIG. 3b is similar to FIG. 3a, except that the gesture point is moving counter clockwise (e.g., backward 1-page, decrease volume 10%, scroll up 1-page, change back to browser app, etc). In the example engagement mode shown in FIG. 3c, the user is using a two contact point circular gesture in the clockwise direction. As previously explained, one complete circle can be translated to one complete action but at twice the rate/speed given the addition contact point (e.g., forward 2-pages, increase volume 20%, scroll down 2-pages, change from browser to word processing app, etc). FIG. 3d is similar to FIG. 3c, except that the gesture points are moving counter clockwise (e.g., backward 2-pages, decrease volume 20%, scroll up 2-pages, change back to browser app, etc). As will be appreciated, a similar discussion applies to circular gestures having three, four, five, etc contact points. Further recall that not all points need to be in motion, so long as the collective set of points uniquely identifies the desired action. Any combination of fixed activation or modifier points and/or motioning points can be used to affect any number of actions.

As can be further seen in the example scenarios of FIGS. 3a-d, the contact points are provided by the user's fingers. Of course, the various contact points can be made with other fingers, styluses, or any other implement or body part that can provide the requisite impact on the touch sensitive surface. Further note that the various provided contact points do not need to be aligned in anyway or otherwise grouped together, but rather can each be provided on a designated or otherwise suitable location of the touch sensitive surface. For example, in some such embodiments, the activation point can be provided in a specific region of the touch sensitive surface (e.g., as designated in a configuration page, as previously explained), while the gesture point can be provided anywhere else on the touch sensitive surface. In a more general sense, any portion of the touch sensitive surface can be used as a fixed activation point and any other location of that surface can be used to provide the circular gesture point. Likewise, as previously explained, a hardware button press (or other such hardware-based indication) may also be used in place of the activation point. Numerous uniquely identifiable activation-gesture point and gesture-only point schemes can be used as will be appreciated in light of this disclosure.

Methodology

FIG. 4 illustrates a method for providing a circular gesture mode in an electronic touch sensitive device, in accordance with an embodiment of the present invention. This example methodology may be implemented, for instance, by the UI module of the touch sensitive device shown in FIG. 2a, or the touch sensitive device shown in FIG. 2b (e.g., with the UI provisioned to the client by the server). To this end, the UI can be implemented in software, hardware, firmware, or any combination thereof, as will be appreciated in light of this disclosure.

As can be seen, the method generally includes sensing a user's input by a touch sensitive surface. In general, any touch sensitive device may be used to detect contact with it by one or more fingers and/or styluses or other suitable implements. As soon as the user begins to drag or otherwise move the contact points, the UI code (and/or hardware) can assume a drag gesture has been engaged and track the path of each contact point with respect to any fixed point within the touch surface until the user stops engaging the touch sensitive surface. The release point can also be captured by the UI as it may be used to commit the action started when the user pressed on the touch sensitive surface. In a similar fashion, if the user releases hold without moving the contact point, a press or press-and-hold command may be assumed depending on the amount of time the user was continually pressing on the touch sensitive surface. These main detections can be used in various ways to implement UI functionality, including a circular gesture mode as variously described herein, as will be appreciated in light of this disclosure.

In this example case, the method includes detecting 401 multiple user contact points at the touch sensitive interface. In general, the touch monitoring is effectively continuous. The method continues with determining 403 if the contact points indicate that the circular gesture mode is desired. As previously explained, this desire may be communicated by, for example, a combination of one or more fixed activation or modifier contact points and one or more circular gesture contact points, or by two or more circular gesture contact points (with no activation points). In some cases, the activation/modifier contact points can be provided in a specific zone of the touch sensitive surface. As previously indicated, one example activation zone is the edge or perimeter of the touch sensitive surface. Other embodiments may have the activation zone anywhere on the touch sensitive surface that is specified by the user via a configuration menu. In a more general sense, the circular gesture mode activation zone can be pre-established in any specific location on the touch sensitive surface of the device. Some embodiments don't use an activation zone for fixed points.

In any case, if the contact does not indicate that the circular gesture mode is desired, then the method may continue with reviewing 404 the contact for some other UI request (e.g., select a file, send an email, etc). On the other hand, if the contact does indicate that the circular gesture mode is desired, the method continues with activating 405 the circular gesture mode, or otherwise maintaining the mode if already activated. The method continues with identifying 407 a desired action based in least at part on the contact, and possibly on the mode configuration. Recall that the mode may be configured by the user to a given extent, in some embodiments. Other embodiments, however, may be hard-coded or otherwise configured to carry out certain specific actions without allowing for user configuration, as will be further appreciated in light of this disclosure.

The method continues with determining 409 whether the desired action is a specific function within an active application. If so, then the method continues with executing 410 the desired action within the active application. For instance, the specific action identified based on the contact and/or mode configuration can be a page turn action within an eBook reader application. In such a case, the page of the eBook is advanced forward (or backward) one or more pages, as previously explained.

If the desired action is not a specific function within an active application, then the method continues with determining 411 whether the desired action is a tool switch within an active application. If so, then the method continues with switching 412 to or otherwise engaging the desired tool. If the desired action is not a tool switch within an active application, then the method continues with determining 413 whether the desired action is an application switch from one application to another (or otherwise engaging an application). If so, then the method continues with switching 414 to or otherwise engaging the desired application. If the desired action is not an application switch, then the method continues with a default action at 415, such as exiting the circular gesture mode or doing nothing until further user contact/input is received. Likewise, the received contact can be reviewed for some other UI request, as done at 404.

The method may continue in the touch monitoring mode indefinitely or as otherwise desired, so that any contact provided by the user can be evaluated for use in the circular gesture mode if appropriate. As previously indicated, the circular gesture mode can be exited by, for example, the user removing the activation contact point or pressing a release mode UI feature such as the home button or a touch screen feature.

Numerous variations and embodiments will be apparent in light of this disclosure. One example embodiment of the present invention provides a device including a display for displaying content to a user, a touch sensitive surface for allowing user input, and a user interface including a circular gesture mode that is configured to be activated in response to user contact via the touch sensitive interface, the user contact including at least two or more moving circular gesture points, or at least one fixed activation point and one or more moving circular gesture points, wherein the user contact indicates a specific desired action. In some cases, the display is a touch screen display that includes the touch sensitive surface. In some cases, the touch sensitive surface is a track pad. In some cases, the quantity of the moving circular gesture points defines a rate or speed at which the desired action is to be carried out. In some cases, the desired action indicated by the user contact is user-configurable. In some cases, the moving circular gesture points have a direction that is either clockwise or counter-clockwise, and the direction dictates whether the desired action causes at least one of forward or backward page advancement, up or down scrolling, or an increase or decrease in value of an object being acted on by the device. In some cases, the desired action is to activate a specific tool or application. In some cases, the at least one fixed activation point, if provided, is a press-and-hold contact on the touch sensitive surface, and the circular gesture mode remains enabled until the press-and-hold contact is released. In other cases, the at least one fixed activation point, if provided, is a press-and-release contact on the touch sensitive surface, and the circular gesture mode remains enabled after release of the press-and-release contact and until the circular gesture mode is terminated. In some cases, the at least one fixed activation point, if provided, has a location that is user-configurable. In some cases, the at least one fixed activation point, if provided, is received from a first hand of the user and the moving circular gesture points are received from another hand of the user.

Another embodiment of the present invention provides a device having a display having a touch screen interface and for displaying content to a user, and a user interface including a circular gesture mode that is configured to be activated in response to user contact via the touch sensitive interface, the user contact including at least two or more moving circular gesture points, wherein the user contact indicates a specific desired action. The quantity of the two or more moving circular gesture points defines a rate or speed at which the desired action is to be carried out. In some cases, the user contact further includes a fixed activation point that is received from a first hand of the user and the one or more moving circular gesture points are received from another hand of the user, and wherein the fixed activation point has a location and at least one of the location and/or the desired action indicated by the user contact is user-configurable. In one such case, the fixed activation point is a press-and-hold contact on the touch screen interface, and the circular gesture mode remains enabled until the press-and-hold contact is released. In another such case, the fixed activation point is a press-and-release contact on the touch screen interface, and the circular gesture mode remains enabled after release of the press-and-release contact and until the circular gesture mode is affirmatively terminated. In some cases, the device is an eReader device or a tablet computer or a smartphone.

Another embodiment of the present invention provides a computer readable medium encoded with instructions that when executed by one or more processors, cause a process to be carried out. The process includes, in response to user contact via a touch sensitive interface of a device capable of displaying content, activating a circular gesture mode in the device, the user contact including at least two or more moving circular gesture points, or at least one fixed activation point and one or more moving circular gesture points, wherein the user contact indicates a specific desired action, and executing the desired action. In some cases, the quantity of the one or more moving circular gesture points defines a rate or speed at which the desired action is to be carried out. In some cases, the desired action indicated by the user contact is user-configurable. In some cases, the user contact includes two or more moving circular gesture points, and wherein the quantity of the two or more moving circular gesture points defines a rate or speed at which the desired action is to be carried out.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive surface for allowing user input; and
a user interface including a circular gesture mode that is configured to be activated in response to user contact via the touch sensitive interface, the user contact including at least two or more moving circular gesture points, or at least one fixed activation point and one or more moving circular gesture points, wherein the user contact indicates a specific desired action.

2. The device of claim 1 wherein the display is a touch screen display that includes the touch sensitive surface.

3. The device of claim 1 wherein the touch sensitive surface is a track pad.

4. The device of claim 1 wherein the quantity of the moving circular gesture points defines a rate or speed at which the desired action is to be carried out.

5. The device of claim 1 wherein the desired action indicated by the user contact is user-configurable.

6. The device of claim 1 wherein the moving circular gesture points have a direction that is either clockwise or counter-clockwise, and the direction dictates whether the desired action causes at least one of forward or backward page advancement, up or down scrolling, or an increase or decrease in value of an object being acted on by the device.

7. The device of claim 1 wherein the desired action is to activate a specific tool or application.

8. The device of claim 1 wherein the at least one fixed activation point, if provided, is a press-and-hold contact on the touch sensitive surface, and the circular gesture mode remains enabled until the press-and-hold contact is released.

9. The device of claim 1 wherein the at least one fixed activation point, if provided, is a press-and-release contact on the touch sensitive surface, and the circular gesture mode remains enabled after release of the press-and-release contact and until the circular gesture mode is terminated.

10. The device of claim 1 wherein the at least one fixed activation point, if provided, has a location that is user-configurable.

11. The device of claim 1 wherein the at least one fixed activation point, if provided, is received from a first hand of the user and the moving circular gesture points are received from another hand of the user.

12. A device, comprising:
a display having a touch screen interface and for displaying content to a user; and
a user interface including a circular gesture mode that is configured to be activated in response to user contact via the touch sensitive interface, the user contact including at least two or more moving circular gesture points, wherein the user contact indicates a specific desired action;
wherein the quantity of the two or more moving circular gesture points defines a rate or speed at which the desired action is to be carried out.

13. The device of claim 12 wherein the user contact further includes a fixed activation point that is received from a first hand of the user and the one or more moving circular gesture points are received from another hand of the user, and wherein the fixed activation point has a location and at least one of the location and/or the desired action indicated by the user contact is user-configurable.

14. The device of claim 13 wherein the fixed activation point is a press-and-hold contact on the touch screen interface, and the circular gesture mode remains enabled until the press-and-hold contact is released.

15. The device of claim 13 wherein the fixed activation point is a press-and-release contact on the touch screen interface, and the circular gesture mode remains enabled after release of the press-and-release contact and until the circular gesture mode is affirmatively terminated.

16. The device of claim 12 wherein the device is an eReader device or a tablet computer or a smartphone.

17. A computer readable medium encoded with instructions that when executed by one or more processors, cause a process to be carried out, the process comprising:
in response to user contact via a touch sensitive interface of a device capable of displaying content, activating a circular gesture mode in the device, the user contact including at least two or more moving circular gesture points, or at least one fixed activation point and one or more moving circular gesture points, wherein the user contact indicates a specific desired action; and
executing the desired action.

18. The computer readable medium of claim 17 wherein the quantity of the one or more moving circular gesture points defines a rate or speed at which the desired action is to be carried out.

19. The computer readable medium of claim 17 wherein the desired action indicated by the user contact is user-configurable.

20. The computer readable medium of claim 17 wherein the user contact includes two or more moving circular gesture points, and wherein the quantity of the two or more moving circular gesture points defines a rate or speed at which the desired action is to be carried out.
